(19) United States
(12) Patent Application Publication
(10) Pub. No.: US 2025/0390215 A1
(43) Pub. Date: Dec. 25, 2025

(54) ELECTRONIC DEVICE COMPRISING FLEXIBLE DISPLAY, AND METHOD FOR CONTROLLING DISPLAY

(71) Applicant: Samsung Electronics Co., Ltd., Suwon-si (KR)

(72) Inventor: Jungjin YOO, Suwon-si (KR)

(21) Appl. No.: 19/313,164

(22) Filed: Aug. 28, 2025

Related U.S. Application Data
(63) Continuation of application No. PCT/KR2024/000777, filed on Jan. 16, 2024.

(30) Foreign Application Priority Data
Mar. 2, 2023 (KR) 10-2023-0028072
Mar. 22, 2023 (KR) 10-2023-0037388

(51) Int. Cl. G06F 3/04886; G06F 3/04842; G06F 3/14; G06F 3/16

(52) U.S. Cl. CPC G06F 3/04886; G06F 3/04842; G06F 3/1423; G06F 3/167

(57) ABSTRACT

A method for display in an electronic device is provided. The method includes outputting a first character input screen to a first display in a first operation state, and outputting a second character input screen, providing continuity of character input in the first display, to a second display in response to an occurrence of a transition event from the first operation state to a second operation state, wherein the first display, which is activated in the first operation state, has a relatively smaller screen size than the second display, which is activated in the second operation state, and wherein the second character input screen includes an input interface provided with having one or more input buttons for selecting a character input method used in the first operation state.

### CROSS-REFERENCE TO RELATED APPLICATION(S)

This application is a continuation application, claiming priority under 35 U.S.C. § 365 (c), of an International application No. PCT/KR2024/000777, filed on Jan. 16, 2024, which is based on and claims the benefit of a Korean patent application number 10-2023-0028072, filed on Mar. 2, 2023, in the Korean Intellectual Property Office, and of a Korean patent application number 10-2023-0037388, filed on Mar. 22, 2023, in the Korean Intellectual Property Office, the disclosure of each of which is incorporated by reference herein in its entirety.

### BACKGROUND

### 1. Field

The disclosure relates to a device and method for controlling a display in an electronic device including a flexible display.

### 2. Description of Related Art

Electronic devices, such as smart phones, mobile phones, and tablet devices, may be representative examples of electronic devices that are easily carried by users. The electronic device may be transitioning into a new form factor, deviating from traditional designs like the bar type. A typical example is an electronic device featuring a flexible display that may be bent or folded, and such foldable electronic devices are produced and marketed as products.

The foldable electronic device may employ a different method for operating the display based on the folder's state. For example, when the folder is folded, an externally exposed display may be activated. For example, when the folder is unfolded, a display that is not exposed to the outside while folded but is exposed to the outside when unfolded may be activated. The foldable electronic device needs to separately provide an input interface (or a user interface) that may be used for each activated display.

Therefore, because the foldable electronic device may offer different input interfaces for each display, it is required to ensure the continuity of the input method when transitioning from the folding state to the unfolding state while utilizing the function that uses the input interface.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a device and a method for updating a character input screen considering a change in a state of a display in an electronic device including a flexible display.

Additional aspects will be set forth in part in the description which follows and, in part, will be apparent from the description, or may be learned by practice of the presented embodiments.

In accordance with an aspect of the disclosure, a method for display in an electronic device is provided. The method includes outputting a first character input screen to a first display in a first operation state, outputting a second character input screen, providing continuity of character input in the first display, to a second display in response to an occurrence of a transition event from the first operation state to a second operation state, wherein the first display, which is activated in the first operation state, has a relatively smaller screen size than the second display, which is activated in the second operation state, and wherein the second character input screen includes an input interface having one or more input buttons for selecting a character input method used in the first operation state.

In accordance with another aspect of the disclosure, an electronic device is provided. The electronic device includes a first display, a second display having a relatively larger screen size than the first display, memory, comprising one or more storage media, storing instructions, and at least one processor communicatively coupled to the first display or the second display, and the memory, wherein the instructions, when executed by the at least one processor individually or collectively, cause the electronic device to control the first display to output a first character input screen in a first operation state and control the second display to output a second character input screen, providing continuity of character input in the first display, in response to an occurrence of a transition event from the first operation state to a second operation state, wherein the second character input screen is configured to include an input interface having one or more input buttons for selecting a character input method used in the first operation state.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include outputting a first character input screen to a first display in a first operation state, and outputting a second character input screen, providing continuity of character input in the first display, to a second display in response to an occurrence of a transition event from the first operation state to a second operation state, wherein the first display, which is activated in the first operation state, has a relatively smaller screen size than the second display, which is activated in the second operation state, and wherein the second character input screen includes an input interface having one or more input buttons for selecting a character input method used in the first operation state.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram illustrating a display device according to an embodiment of the disclosure;

FIG. 3 is a state transition diagram for providing a character input screen based on an operation state in an electronic device according to an embodiment of the disclosure;

FIG. 4 is a control flowchart for providing a character input screen based on an operation state in an electronic device, according to an embodiment of the disclosure;

FIG. 5A is a view illustrating a character input by an emoji in a first operation state of an electronic device according to an embodiment of the disclosure;

FIG. 5B is a view illustrating a character input by a voice in a first operation state by an electronic device according to an embodiment of the disclosure;

FIG. 6A is a view illustrating an example of changing a character input screen when an operation state of an electronic device is changed, according to an embodiment of the disclosure;

FIG. 6B is a view illustrating an example of changing a screen in order to continuously provide a voice input when an operation state is changed in an electronic device according to an embodiment of the disclosure;

FIG. 6C is a view illustrating an example of changing a screen in order to continuously provide an emoji input when an operation state is changed in an electronic device, according to an embodiment of the disclosure;

FIG. 7A is a view illustrating an example of changing a screen in order to continuously provide a character input when an operation state is changed in an electronic device according to an embodiment of the disclosure;

FIG. 7B is a view illustrating an example of changing a screen in order to continuously provide a character input when an operation state is changed in an electronic device according to an embodiment of the disclosure;

FIG. 7C is a view illustrating an example of changing a screen in order to continuously provide a character input when an operation state is changed in an electronic device according to an embodiment of the disclosure; and

FIG. 8 is a block diagram illustrating an electronic device including a flexible display according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions is of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

According to an embodiment of the disclosure, even when an operation state is changed (e.g., from the folding state to the unfolding state) in an electronic device having a flexible display so that the activated display is changed, continuity in the use of the character input method used in the previous operation state may be guaranteed.

The technical objects of the disclosure are not limited to the foregoing, and other technical objects may be derived by one of ordinary skill in the art from example embodiments of the disclosure.

Effects of the disclosure are not limited to the foregoing, and other unmentioned effects would be apparent to one of ordinary skill in the art from the following description. In other words, unintended effects in practicing embodiments of the disclosure may also be derived by one of ordinary skill in the art from example embodiments of the disclosure.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

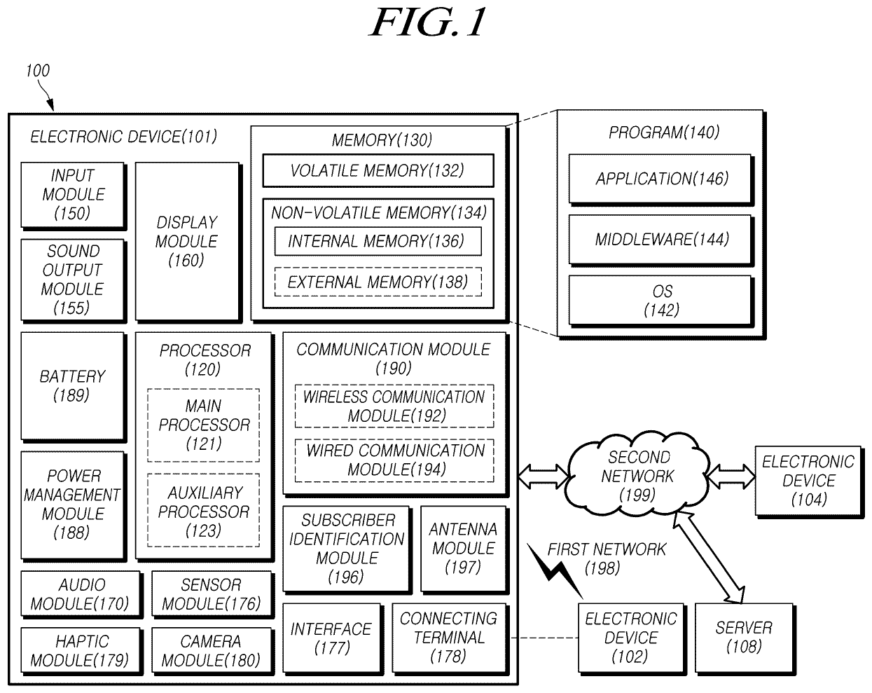

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). In an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In another embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134 which includes an internal memory 136 and an external memory 138. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to another embodiment, the auxiliary processor 123 (e.g., an image signal processor or a communication processor) may be implemented as part of another component (e.g., the camera module 180 or the communication module 190) functionally related to the auxiliary processor 123. In an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store, for example, various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to another embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. In an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to another embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. In another embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to another embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. The communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to another embodiment, the antenna module 197 may include an antenna including a radiator formed of a conductor or conductive pattern formed on a substrate (e.g., a printed circuit board (PCB)). According to yet another embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

Commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform, for example, the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. In an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

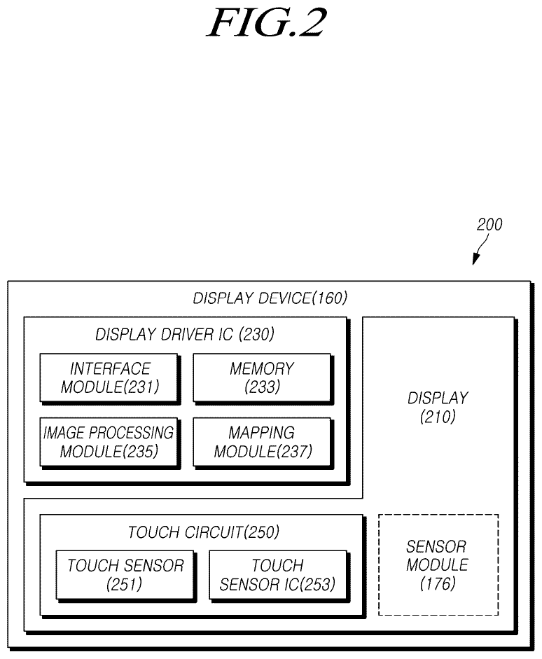

FIG. 2 is a block diagram 200 illustrating the display device 160 according to an embodiment of the disclosure.

Referring to FIG. 2, the display device 160 may include a display 210 and a display driver integrated circuit (DDI) 230 to control the display 110. The DDI 230 may include an interface module 231, memory 233 (e.g., a buffer memory), an image processing module 235, or a mapping module 237. The DDI 230 may receive image information that contains image data or an image control signal corresponding to a command for controlling the image data from the processor 120 (e.g., the main processor 121 (e.g., an application processor) or the auxiliary processor 123 operated independently from the function of the main processor 121) through, e.g., the interface module 231. The DDI 230 may communicate, for example, with touch circuitry 250 or the sensor module 176 via the interface module 231. The DDI 230 may also store at least part of the received image information in the memory 233, for example, on a frame by frame basis. The image processing module 235 may perform pre-processing or post-processing (e.g., adjustment of resolution, brightness, or size) with respect to at least part of the image data. According to another embodiment, the pre-processing or post-processing may be performed, for example, based at least in part on one or more characteristics of the image data or one or more characteristics of the display 210. The mapping module 237 may convert the image data pre- or post-processed by the image processing module 135 into a voltage value or current value at which pixels of the display 210 may be driven, based on, at least, at least part of attributes of the pixels (e.g., the array (RGB stripe or pentile)) of the pixels or the size of each subpixel). At least some pixels of the display 210 may be driven based on, e.g., the voltage value or current value so that visual information (e.g., text, image, or icon) corresponding to the image data may be displayed on the display 210.

According to yet another embodiment, the display device 160 may further include the touch circuitry 250. The touch circuitry 250 may include a touch sensor 251 and a touch sensor IC 253 to control the touch sensor 151. The touch sensor IC 253 may control the touch sensor 251, sense a touch input or hovering input at a particular position of the display 210, e.g., by measuring a variation in a signal (e.g., a voltage, quantity of light, resistance, or quantity of electric charge) for the particular position of the display 210, and provide information (e.g., the position, area, pressure, or time) regarding the sensed touch input or hovering input to the processor 120. According to an embodiment, at least part (e.g., the touch sensor IC 253) of the touch circuitry 250 may be formed as part of the display 210 or the DDI 230, or as part of another component (e.g., the auxiliary processor 123) disposed outside the display device 160.

In an embodiment, the display device 160 may further include at least one sensor (e.g., a fingerprint sensor, an iris sensor, a pressure sensor, or an illuminance sensor) of the sensor module 176 or a control circuit for the at least one sensor. In such a case, the at least one sensor or the control circuit for the at least one sensor may be embedded in one portion of a component (e.g., the display 210, the DDI 230, or the touch circuitry 250)) of the display device 160. For example, when the sensor module 176 embedded in the display device 160 includes a biometric sensor (e.g., a fingerprint sensor), the biometric sensor may obtain biometric information (e.g., a fingerprint image) corresponding to a touch input received via a portion of the display 210. As another example, when the sensor module 176 embedded in the display device 160 includes a pressure sensor, the pressure sensor may obtain pressure information corresponding to a touch input received via a partial or whole area of the display 210. According to an embodiment, the touch sensor 251 or the sensor module 176 may be disposed between pixels in a pixel layer of the display 210, or over or under the pixel layer.

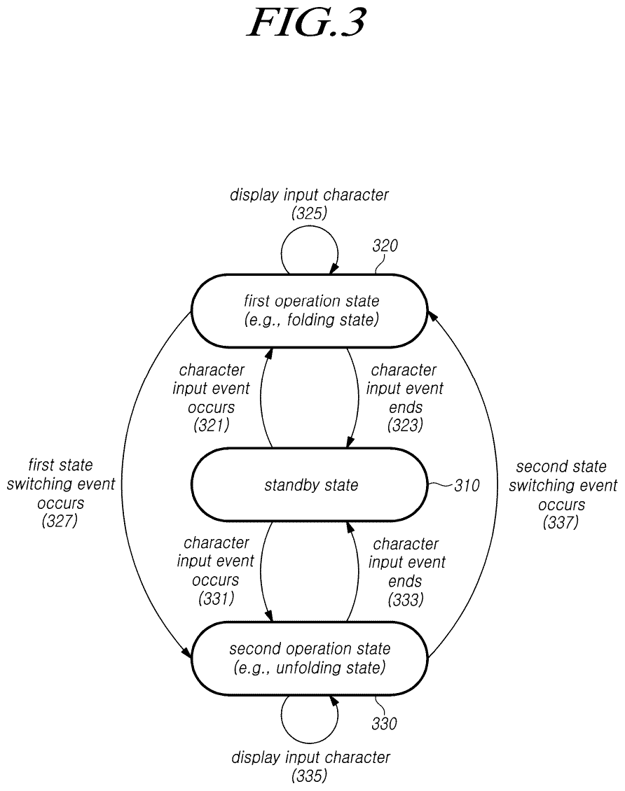

FIG. 3 is a state transition diagram for providing a character input screen based on an operation state (e.g., a folding state or an unfolding state) in an electronic device (e.g., the electronic device 100 of FIG. 1) according to an embodiment of the disclosure.

Referring to FIG. 3, e.g., an operation state for performing a character input function in the electronic device 100 may include a standby state 310, a first operation state 320, or a second operation state 330. The electronic device 100 may include a display whose size is variable, such as foldable, slidable, rollable, or multi-foldable. The first operation state 320 may be an operation state in which the area of the display is relatively narrow. The first operation state 320 may be, e.g., a folding state or a roll-down state. The second operation state 330 may be an operation state in which the area of the display is relatively large. The second operation state 330 may be, e.g., an unfolding state or a roll-up state. In the following description, for convenience, the first operation state 320 is assumed to be the folding state, and the second operation state 330 is assumed to be the unfolding state. However, the first operation state 320 or the second operation state 330 does not have to be specified as the folding state or the unfolding state.

In the electronic device 100, the character input function may be activated, for example, in response to the execution of an application program requiring the user to input information, such as a text message, chat, or search. The character input function may be classified by the character input method. The character input method may include, e.g., a key input method using a character keypad, a voice input method using voice, or an emoji input method using emojis. In the electronic device 100, a character input method that may be supported for each operation state may be set.

The electronic device 100 may support, e.g., a voice input method or an emoji input method as the character input method in the first operation state 320 in which the area of the display is limited. The electronic device 100 may support a key input method using a keypad as the character input method in the second operation state 330 in which there is relatively no limitation on the area of the display compared to the first operation state 320. The electronic device 100 is not limited to supporting only key input methods as the character input method in the second operation state 330. In other words, the electronic device 100 may support a voice input method or an emoji input method as the character input method in addition to a key input method in the second operation state 330. For example, the electronic device 100 simply gives priority to the key input method in the second operation state 330, and may support at least one of the voice input method or the emoji input method as the character input method if necessary. In another example, if a specific character input method has been selected or used in the first operation state 320, the electronic device 100 may provide support for selecting or using the specific character input method in the second operation state 330.

When character input is not required, the electronic device 100 may operate in a standby state 310. The standby state 310 may be an operation state in which the character input function is not activated. In the standby state 310, the electronic device 100 may maintain all of the displays in the inactive state.

In the following description, for convenience, it is assumed that the electronic device 100 is a foldable device having a foldable display. In this case, the first operation state 320 may be the folding state, and the second operation state 330 may be the unfolding state.

The electronic device 100 may monitor whether a character input event occurs in the standby state 310. In an embodiment, the character input event may be triggered by an occurrence of a circumstance in which character input is required. The circumstance in which the character input is required may occur, e.g., when the character input function is required to be activated. The character input function may be activated in response to the execution of an application program requiring information input by the user, such as a text message function, a chat function, or a search function. When the character input function is activated, the electronic device 100 may transition from the standby state 310 to the first operation state 320 or the second operation state 330. The electronic device 100 will transition from the standby state 310 to the first operation state 320, e.g., if the character input event occurs in the folding state at operation 321. The electronic device 100 will transition from the standby state 310 to the second operation state 320, e.g., if the character input event occurs in the unfolding state at operation 331. The first operation state 320 may be an operation state in which the electronic device 100 may perform the character input function in the folding state. The second operation state 330 may be an operation state in which the electronic device 100 may perform the character input function in the unfolding state.

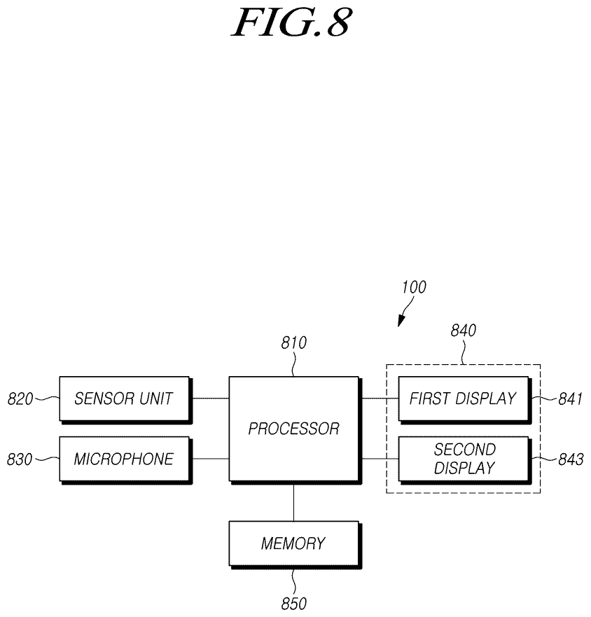

When the electronic device 100 transitions from the standby state 310 to the second operation state 330, the electronic device 100 may output a screen corresponding to the generated character input event to the display (e.g., the second display 843 of FIG. 8) that may be used in the unfolding state. In another embodiment, the screen to be output to the second display 843 may be determined by the type that generates the character input event. For example, if the character input event is based on the reception of a text message, the electronic device 100 may output a character input screen including a keypad to support the character input method (e.g., a key input method) to input an answer text along with the received text to the second display 843.

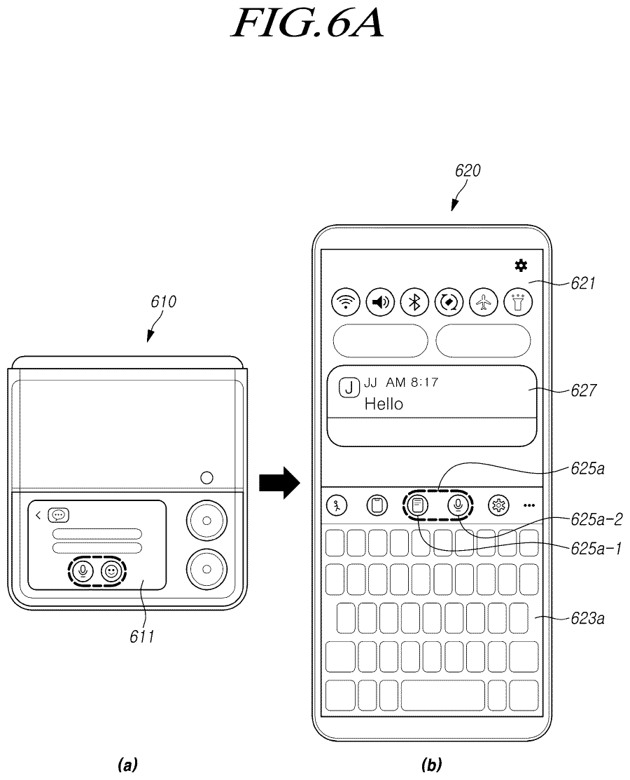

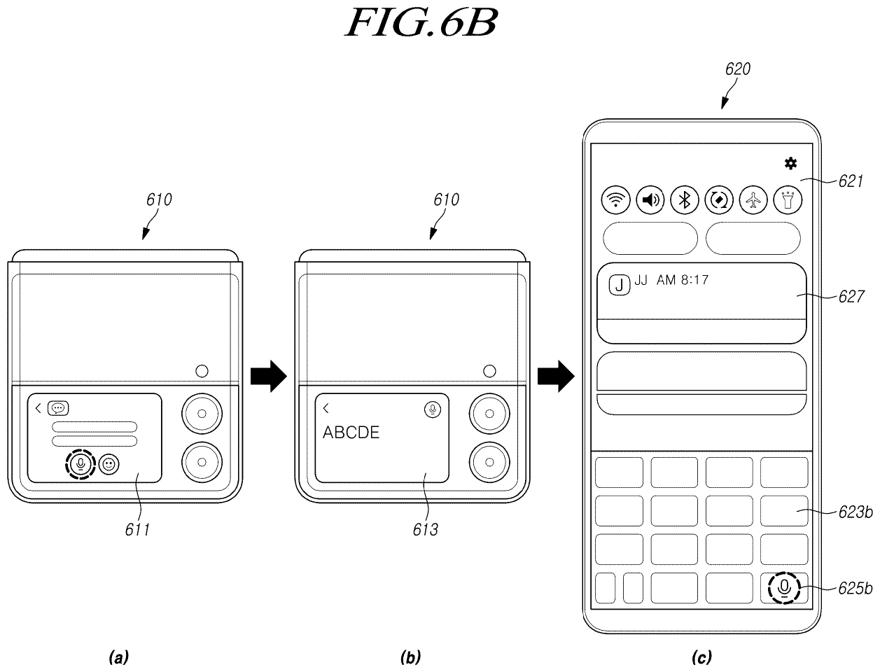

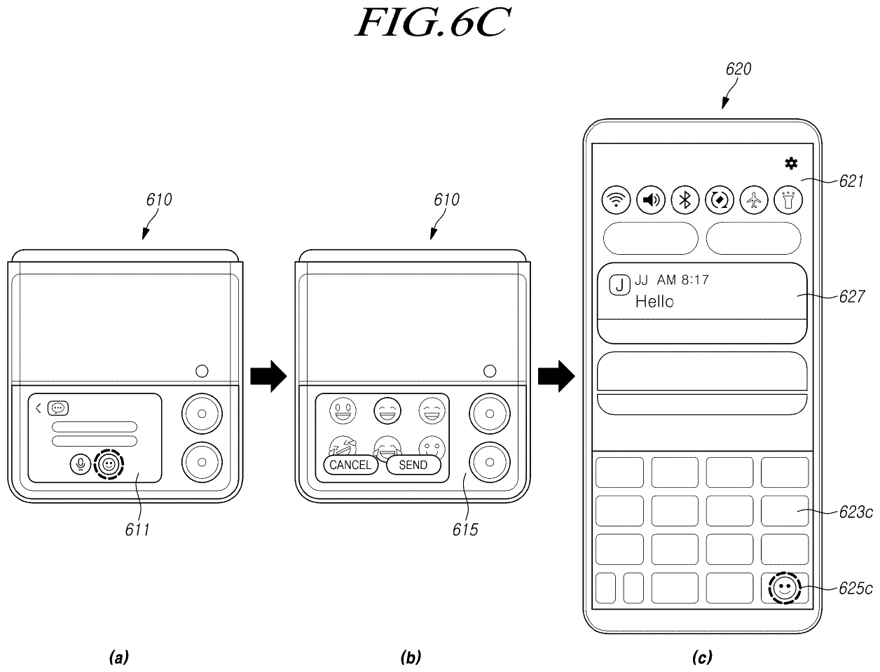

When the electronic device 100 transitions from the standby state 310 to the first operation state 320, the electronic device 100 may output a screen corresponding to the generated character input event to the display (e.g., the first display 841 of FIG. 8) that may be used in the folding state. The screen to be output to the first display 841 may be determined by the type that generates the character input event. For example, if the character input event is based on the reception of the text message, the electronic device 100 may output a character input screen (e.g., the first character input screen 611 of FIG. 6A, 6B, or 6C) that includes a button for selecting the character input method (e.g., voice input or emoji input) to input the answer text along with the received text to the first display 841.

The electronic device 100 may select a button for determining the character input method by the user in the first operation state 320, and display a character input by the character input method corresponding to the selected button on the first display 841 (325).

For example, when the emoji input method is selected as the character input method, the electronic device 100 may output emojis that the user may select to the first display 841. If the user selects at least one emoji from among the emojis output to the first display 841, the electronic device 100 may display the character corresponding to the selected at least one emoji on the first display 841.

In another example, when the voice input method is selected as the character input method, the electronic device 100 may display a button for the user to start or end the voice input on the first display 841. When the user inputs a voice by manipulating the button displayed to the first display 841, the electronic device 100 may display the character corresponding to the input voice on the first display 841 or execute a command corresponding to the voice.

When a character input end event occurs in the folding state, the electronic device 100 may transition from the first operation state 320 to the standby state 310 at operation 323. If the electronic device transitions to the standby state 310, the electronic device may deactivate the first display 841 used in the folding state.

If a first state switching event occurs in the first operation state 320, the electronic device 100 may transition from the first operation state 320 to the second operation state 330 at operation 327. The first state switching event may be generated, e.g., by switching the electronic device 100 from the folding state to the unfolding state. If the electronic device 100 transitions to the second operation state 330, the electronic device 100 may output a screen corresponding to the generated character input event to the display (e.g., the second display 843 of FIG. 8) that may be used in the unfolding state. The screen to be output to the second display 843 may be determined by the type that generated the character input event and the character input method (e.g., the voice input method or the emoji input method) that may be provided in the first operation state 320. If the character input event is based on the reception of a text message and the character input method in the first operation state 320 is the emoji input method, the electronic device 100 may output a character input screen (e.g., an input interface) including a button for selecting the emoji input method used in the first operation state 320 along with the received text to the second display 843.

When one of the character input methods provided in the first operation state 320 included in the input interface is selected by the user in the second operation state 330, the electronic device 100 may provide the character input method provided in the first operation state 320, even in the second operation state 330. In this case, the user may continuously use the character input method used in the first operation state 320 even in the second operation state 330. For example, the electronic device 100 may select a button included in the input interface corresponding to the character input method used by the user in the first operation state 320, and display the character input by the character input method corresponding to the selected button on the second display 843 at operation 335.

For example, when the emoji input method is selected as the character input method in the first operation state 320 or is used, the electronic device 100 may output emojis selectable by the user to the second display 843. If the user selects at least one emoji from among the emojis output to the second display 843, the electronic device 100 may display the character corresponding to the selected at least one emoji on the second display 843.

When the voice input method is selected as the character input method in the first operation state 320 or is used, the electronic device 100 may display a button for the user to start or end the voice input on the second display 843. If the user inputs a voice by manipulating the button displayed on the second display 843, the electronic device 100 may display the character corresponding to the input voice to the second display 843 or execute a command corresponding to the voice.

If a character input end event occurs in the unfolding state, the electronic device 100 may transition from the second operation state 330 to the standby state 310 at operation 333. If the electronic device transitions to the standby state 310, the electronic device may deactivate the second display 843 used in the unfolding state. The character input end event in the unfolding state may be generated, e.g., by switching from the unfolding state to the folding state.

If a second state switching event occurs in the second operation state 330, the electronic device 100 may transition from the second operation state 330 to the first operation state 320 at operation 337. The second state switching event may be generated, e.g., by the user's request to maintain character input while switching from the unfolding state to the folding state. If the electronic device 100 transitions to the first operation state 320, and if the character input method (e.g., the voice input method or the emoji input method) that may be supported in the folding state was being used in the unfolding state, the electronic device 100 may output a character input screen capable of character input by the corresponding character input method to the first display 841.

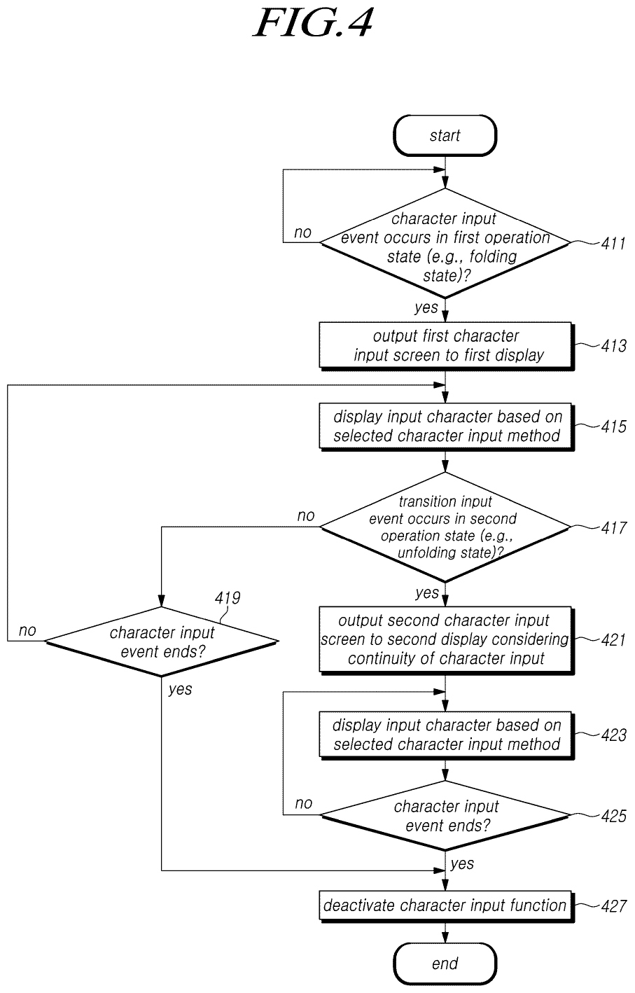

FIG. 4 is a control flowchart for providing a character input screen based on an operation state (e.g., the folding state or the unfolding state) in an electronic device (e.g., the electronic device 100 of FIG. 1) according to an embodiment of the disclosure.

Referring to FIG. 4, the electronic device 100 may determine whether a character input event occurs in a first operation state (e.g., the first operation state 320 of FIG. 3) at operation 411. The first operation state 320 may be, e.g., the folding state or the roll-down state. The character input event may occur, e.g., by receiving a text message or chat text, or by executing an application program that provides a text message function or chat function (e.g., Kakao talk), or by executing an application program (e.g., Netflix, YouTube) that provides a search function by character input.

If the character input event occurs in the first operation state 320, the electronic device 100 may output a first character input screen (e.g., the first character input screen 611 of FIG. 6A, 6B, or 6C) to the first display (e.g., the first display 841 of FIG. 8) at operation 413. The first character input screen may be, e.g., a screen supporting the character input method (e.g., the voice input method or the emoji input method) capable of character input using the first display 841 activated in the first operation state 320. For example, the electronic device 100 may output a button for selecting the character input method available in the first operation state 320 to the first display 841.

If one of the buttons corresponding to the character input method displayed on the first display 841 is selected by the user, the electronic device 100 may switch the character input screen to a screen (e.g., FIG. 6B or part (b) of FIG. 6C) capable of supporting character input by the character input method corresponding to the selected button at operation 415. The switched screen (e.g., part (b) of FIG. 6B) may include, e.g., the voice input start/end selection button (e.g., the voice start/end button 625b of FIG. 6B). The switched screen (e.g., part (b) of FIG. 6C) may include, e.g., selectable emojis (e.g., the emojis on the first character input screen 615 of FIG. 6C). The electronic device 100 may display the text (e.g., voice or emoji) input by the selected character input method to the first display 841 at operation 415.

In an example, when the emoji input method is selected as the character input method, the electronic device 100 may output emojis that the user may select to the first display 841. If the user selects at least one emoji from among the emojis output to the first display 841, the electronic device 100 may display the character corresponding to the selected at least one emoji on the first display 841.

In another example, when the voice input method is selected as the character input method, the electronic device 100 may display a button for the user to start or end the voice input on the first display 841. When the user inputs a voice by manipulating the button displayed to the first display 841, the electronic device 100 may display the character corresponding to the input voice on the first display 841 or execute a command corresponding to the voice.

The electronic device 100 may determine whether a first state switching event for switching from the first operation state 320 to the second operation state (e.g., the unfolding state or the roll-up state) (e.g., the second operation state 330 of FIG. 3) occurs at operation 417. The first state switching event may be generated, e.g., by switching the electronic device 100 from the folding state to the unfolding state. The first state switching event may be generated, e.g., by switching the electronic device 100 from the roll-down state to the roll-up state.

The electronic device 100 may determine whether a character input end event occurs in the first operation state 320 at operation 419. The character input end event may occur, e.g., by terminating the use of the application program requiring character input.

If a switching event from the first operation state 320 to the second operation state 330 occurs, the electronic device 100 may output a second character input screen (e.g., the second character input screen 621 of FIG. 6A, 6B, or 6C) considering character input continuity to a display (e.g., the second display 843 of FIG. 8) usable in the second operation state 330 at operation 421. The second character input screen 621 to be output to the second display 843 may be determined by the type that generated the character input event and the character input method (e.g., the voice input method or the emoji input method) that may be provided in the first operation state 320.

For example, if the character input event is based on the reception of a text message and the character input method in the first operation state 320 is not selected, the electronic device 100 may output, to the second display 843, a second character input screen (e.g., the second character input screen 621 of FIG. 6A) which includes an input interface (e.g., the input interface 623a of FIG. 6A) with an added button (e.g., the voice input button 625a-1 or the emoji input button 625a-2 of FIG. 6A) for selecting the character input method (e.g., voice input method or emoji input method) available in the first operation state 320 along with the received text. The voice input button 625a-1 may be a button for selecting the voice input method as the character input method. The emoji input button 625a-2 may be a button for selecting the emoji input method as the character input method.

When the character input event is based on the reception of a text message and the character input method in the first operation state 320 is the voice input method, the electronic device 100 may output, to the second display 843, a second character input screen (e.g., the second character input screen 621 of FIG. 6B) which includes an input interface (e.g., the input interface 623b of FIG. 6B) with an added button (e.g., the voice input method selection button 625b of FIG. 6B) for selecting the voice input method used in the first operation state 320 along with the received text.

When the character input event is based on the reception of a text message and the character input method in the first operation state 320 is the emoji input method, the electronic device 100 may output, to the second display 843, a second character input screen (e.g., the second character input screen 621 of FIG. 6C) which includes an input interface (e.g., the input interface 623c of FIG. 6C) with an added button (e.g., the emoji input method selection button 625c of FIG. 6C) for selecting the emoji input method used in the first operation state 320 along with the received text.

If one of the buttons corresponding to the character input method displayed on the second display 843 is selected by the user, the electronic device 100 may switch the character input screen to be displayed on the second display 843 to a screen capable of supporting character input by the character input method corresponding to the selected button at operation 423. The switched screen may include, e.g., the voice input start/end selection button (e.g., the voice start/end button 625b of FIG. 6B). The switched screen may include, e.g., emojis. The electronic device 100 may display the text (e.g., voice or emoji) input by the selected character input method to the first display 841 at operation 423.

For example, when the voice input method is selected as the character input method, if the user inputs a voice by manipulating the button 625b for starting or ending the voice input, the electronic device 100 may display the character corresponding to the input voice to the second display 843 or execute a command corresponding to the voice.

For example, when the emoji input method is selected as the character input method, the electronic device 100 may output emojis that the user may select to the second display 843. If the user selects at least one emoji from among the emojis output to the second display 843, the electronic device 100 may display the character corresponding to the selected at least one emoji on the second display 843.

The electronic device 100 may provide a method to support character input in the second operation state 330 considering the character input circumstance in the first operation state 320 when the switching event to the second operation state 330 occurs.

For example, if the character input method is not selected and the switching event occurs in the first operation state 330, the electronic device 100 may output, to the second display 843, a second character input screen (e.g., the second character input screen 621 of FIG. 6A) including an input interface (e.g., the input interface 623a of FIG. 6A) with an added button (e.g., the voice input button 625a-1 or the emoji input button 625a-2 of FIG. 6A) for selecting all supported character input methods (e.g., voice input method or emoji input method) in the first operation state 320. The voice input button 625a-1 may be a button for selecting the voice input method as the character input method. The emoji input button 625a-2 may be a button for selecting the emoji input method as the character input method.

If the character input method in the first operation state 330 is selected as the voice input method, and a switching event occurs at the time when the character input is not performed, the electronic device 100 may output, to the second display 843, a second character input screen (e.g., the second character input screen 621 of FIG. 6B) including an input interface with an added button (e.g., the voice input button 625b of FIG. 6B) for selecting the voice input method. The voice input button 625b may be a button for selecting the voice input method as the character input method.

For example, if the character input method in the first operation state 330 is selected as the voice input method, and a switching event occurs at the time when character input is started but is not completed (e.g., not sent or sentence not completed), the electronic device 100 may output a second character input screen capable of supporting character input by the voice input method to the second display 843. The second character input screen capable of supporting character input by the voice input method may be, e.g., a screen capable of inputting a voice after the user presses the voice input button.

In another example, if the character input method in the first operation state 330 is selected as the voice input method and a switching event occurs at the time when the character input is completed (e.g., sent or sentence completed), the electronic device 100 may output, to the second display 843, a second character input screen (e.g., the second character input screen 621 of FIG. 6A) including an input interface (e.g., the input interface 623a of FIG. 6A) with an added button (e.g., the voice input button 625a-1 or the emoji input button 625a-2 of FIG. 6A for selecting all supported character input methods (e.g., the voice input method or emoji input method) in the first operation state 320. The voice input button 625a-1 may be a button for selecting the voice input method as the character input method. The emoji input button 625a-2 may be a button for selecting the emoji input method as the character input method.

If the character input method in the first operation state 330 is selected as the emoji input method, and a switching event occurs at the time when the character input is not performed, the electronic device 100 may output, to the second display 843, a second character input screen (e.g., the second character input screen 621 of FIG. 6C) including an input interface (e.g., the input interface 623c of FIG. 6C) with an added button (e.g., the emoji input button 625c of FIG. 6C) for selecting the emoji input method. The emoji input button 625c may be a button for selecting the emoji input method as the character input method.

For example, if the character input method in the first operation state 330 is selected as the emoji input method, and a switching event occurs at the time when the character input is started but is not completed (e.g., not sent or sentence not completed), the electronic device 100 may output, to the second display 843, a second character input screen capable of supporting character input by the emoji input method. The second character input screen capable of supporting character input by the emoji input method may be, e.g., a screen on which emojis selectable by the user are to be displayed.

If the character input method in the first operation state 330 is selected as the emoji input method and a switching event occurs at the time when the character input is completed (e.g., sent or sentence completed), the electronic device 100 may output, to the second display 843, a second character input screen (e.g., the second character input screen 621 of FIG. 6A) including an input interface (e.g., the input interface 623a of FIG. 6A) with an added button (e.g., the voice input button 625a-1 or the emoji input button 625a-2 of FIG. 6A) for selecting all supported character input methods (e.g., the voice input method or the emoji input method). The voice input button 625a-1 may be a button for selecting the voice input method as the character input method. The emoji input button 625a-2 may be a button for selecting the emoji input method as the character input method.

The electronic device 100 may determine whether a character input end event occurs in the second operation state 330 at operation 425. The character input end event may occur, e.g., by terminating the use of the application program requiring character input.

If a character input end event occurs in the first operation state 320 or the second operation state 330, the electronic device 100 may transition to the standby state 310 at operation 427. If the electronic device 100 transitions to the standby state 310, the character input function may be deactivated and the first display 841 or the second display 843 used in the folding state or the unfolding state may be deactivated.

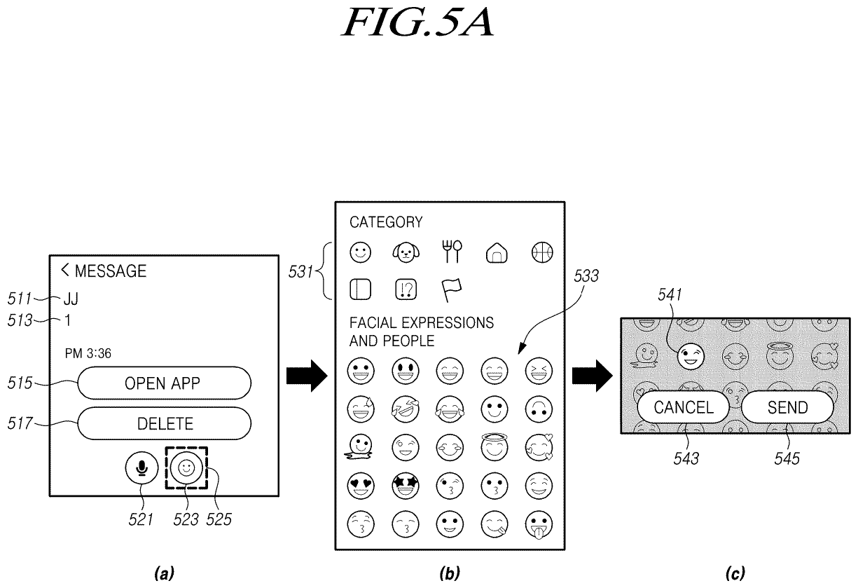

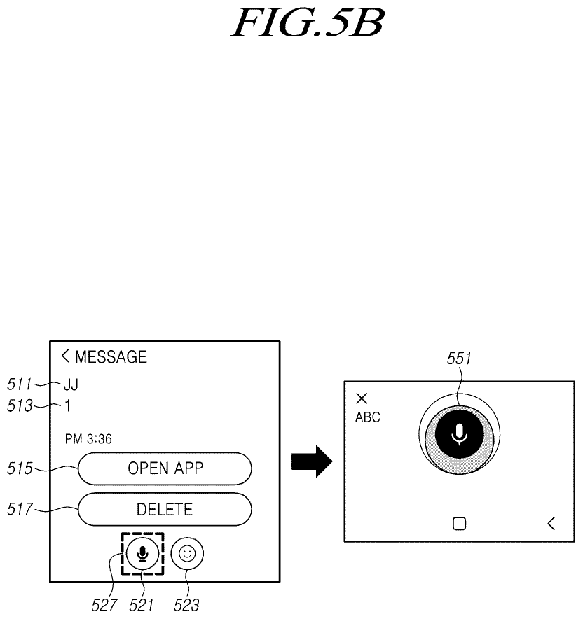

FIG. 5A is a view illustrating, step by step, character input using emojis in a first operation state (e.g., a folding state) by an electronic device (e.g., the electronic device 100 of FIG. 1) according to an embodiment of the disclosure.

Referring to FIG. 5A, the first character input screen a that may be output to the first display (e.g., the first display 841 of FIG. 8) in a first operation state (e.g., the first operation state 320 of FIG. 3) such as the folding state may include a text message, buttons 515 and 517 regarding message processing options, or buttons 521 and 523 to select the character input method. The text message included in the first character input screen a may include, e.g., a sender ‘JJ’ 511 and a message ‘1’ 513. The button regarding the message processing option may include, e.g., a button 515 for requesting to execute an application program (APP) supporting a text message function or a button 517 for requesting deletion of a received text message. The button for selecting the character input method may include, e.g., a button 521 (e.g., the voice input method selection button) for selecting a character input using voice or a button 523 (e.g., the emoji input method selection button) for selecting a character input using emojis.

In an example, the first character input screen b that may be output on the first display (841) includes group emojis 531 for selecting an emoji group or emojis 533 included in the selected group emoji in response to the selection 525 of the emoji input method selection button 523 by the user. The user may select one desired group emoji from among the group emojis 531. In this case, emojis 533 belonging to the selected group emojis may be output on the first character input screen b. The user may select one or more emojis from among the emojis 533 output on the first character input screen b.

In an example, in response to one or more emojis being selected in the first character input screen (b), the first character input screen (c) that can be output to the first display (841) may output the selected one or more emojis (541) and function buttons (543, 545) for processing the selected one or more emojis (541). The function buttons may include, for example, a ‘cancel’ button (543) that requests to deselect the selected one or more emojis (541). The function buttons may include, for example, a ‘send’ button (545) that requests to transmit the selected one or more emojis (541).

FIG. 5B is a view illustrating, step by step, character input by voice in a first operation state (e.g., the electronic device 100 of FIG. 1) by an electronic device (e.g., the electronic device 100 of FIG. 1) according to an embodiment of the disclosure.

Referring to FIG. 5B, the first character input screen a that may be output to the first display (e.g., the first display 841 of FIG. 8) in a first operation state (e.g., the first operation state 320 of FIG. 3) such as the folding state may include a text message, buttons 515 and 517 regarding message processing options, or buttons 521 and 523 to select the character input method. The text message included in the first character input screen a may include, e.g., a sender ‘JJ’ 511 and a message ‘1’ 513. The button regarding the message processing option may include, e.g., a button 515 for requesting to execute an application program (APP) supporting a text message function or a button 517 for requesting deletion of a received text message. The button for selecting the character input method may include, e.g., a button 521 (e.g., the voice input method selection button) for selecting a character input using voice or a button 523 (e.g., the emoji input method selection button) for selecting a character input using emojis.

In response to the selection 527 of the voice input method selection button 521 by the user, the first character input screen b that may be output to the first display 841 may include a function button 551 for starting or terminating the voice input. Further, the first character input screen b may include a function button for selecting a language. The user may press the function button 551 output on the first character input screen b to input voice, and press the function button 551 again to terminate the voice input.

FIG. 6A is a view illustrating an example of changing a character input screen when an operation state (e.g., the folding state or the unfolding state) is changed in an electronic device (e.g., the electronic device 100 of FIG. 1) according to an embodiment of the disclosure.

Referring to FIG. 6A, a first character input screen 611 may be output to the first display (e.g., the first display 841 of FIG. 8) in the folding state 610 (e.g., the first operation state 320 of FIG. 3) (a). The first character input screen 611 may include a text message, a button (e.g., the button 515, 517 of FIG. 5A or 5B) regarding a message processing option, or a button (e.g., the button 521, 523 of FIG. 5A or 5B) for selecting the character input method.

For example, if the electronic device 100 is changed to the unfolding state 620 (e.g., the first operation state 320 of FIG. 3) by the user, the second character input screen 621 may be output to the second display (e.g., the second display 843 of FIG. 8) (b). For example, it is assumed that the change to the unfolding state 620 is made before the character input method is selected after receiving the text message. The second character input screen 621 may be a state display screen that is semi-transparently displayed on the home screen output to the second display 843. Information about the operation state of the electronic device 100 may be output on the state display screen. As information about the operation state, the state display screen may include, e.g., a function activated or deactivated in the electronic device 100 or emojis indicating the state of the function.

When the character input function is activated in the folding state 610 and then changed to the unfolding state 620, the text message 627 that was output on the first character input screen 611 in the folding state 610 may also be output on the second character input screen 621. An input interface 623a may be output on the second character input screen 621 for continuous character input. In addition to the keypad for character input, the input interface 623a may include the character input method selection button 625a for continuously selecting the character input method (e.g., the voice input method or the emoji input method) supported by the folding state 610 even in the unfolding state 620. The character input method selection button 625a may include, e.g., the emoji input method selection button 625a-1 or the voice input method selection button 625a-2. The user may continuously use the character input method used in the folding state 610 even in the unfolding state 620 by selecting one of the emoji input method selection button 625a-1 or the voice input method selection button 625a-2 output on the second character input screen 621.

FIG. 6B is a view illustrating an example of changing a screen in order to continuously provide the voice input when an operation state (e.g., the folding state or the unfolding state) is changed in an electronic device (e.g., the electronic device 100 of FIG. 1) according to an embodiment of the disclosure.

Referring to FIG. 6B, a first character input screen 611 may be output to the first display (e.g., the first display 841 of FIG. 8) in the folding state 610 (e.g., the first operation state 320 of FIG. 3) (a). The first character input screen 611 may include a text message, a button (e.g., the button 515, 517 of FIG. 5A or 5B) regarding a message processing option, or a button (e.g., the button 521, 523 of FIG. 5A or 5B) for selecting the character input method.

For example, a button for selecting the voice input method from among buttons (e.g., the button 521, 523 of FIG. 5A or 5B) to select the character input method output on the first character input screen 611 may be input by the user. In this case, a first character input screen 613 supporting voice input may be output to the first display 841 (b). A function button (e.g., the button 551 of FIG. 5B) for starting or terminating the voice input may be output on the first character input screen 613.

For another example, if the electronic device 100 is changed to the unfolding state 620 (e.g., the first operation state 320 of FIG. 3) by the user, the second character input screen 621 may be output to the second display (e.g., the second display 843 of FIG. 8) (c). For example, it is assumed that the change to the unfolding state 620 is made after receiving a text message and then selecting the voice input method as the character input method. The second character input screen 621 may be a state display screen that is semi-transparently displayed on the home screen output to the second display 843. Information about the operation state of the electronic device 100 may be output on the state display screen. As information about the operation state, the state display screen may include, e.g., a function activated or deactivated in the electronic device 100 or emojis on the second character input screen 621 indicating the state of the function.

For example, when the character input function is activated in the folding state 610 and the voice input method is selected and then changed to the unfolding state 620, the text message 627 output on the first character input screen 611 in the folding state 610 may also be output on the second character input screen 621. An input interface 623b may be output on the second character input screen 621 for continuous character input. In addition to the keypad for character input, the input interface 623b may include the voice input method selection button 625b for continuously selecting the character input method (e.g., the voice input method) selected in the folding state 610 even in the unfolding state 620. The user may continuously use the voice input method used in the folding state 610 even in the unfolding state 620 by selecting the voice input method selection button 625b output on the second character input screen 621.

FIG. 6C is a view illustrating an example of changing a screen in an electronic device (e.g., the electronic device 100 of FIG. 1) in order to continuously provide an emoji input when an operation state (e.g., the folding state or the unfolding state) is changed according to an embodiment of the disclosure.

Referring to FIG. 6C, a first character input screen 611 may be output to the first display (e.g., the first display 841 of FIG. 8) in the folding state 610 (e.g., the first operation state 320 of FIG. 3). The first character input screen 611 may include a text message, a button (e.g., the button 515, 517 of FIG. 5A or 5B) regarding a message processing option, or a button (e.g., the button 521, 523 of FIG. 5A or 5B) for selecting the character input method.

For example, a button for selecting the emoji input method from among buttons (e.g., the button 521, 523 of FIG. 5A or 5B) to select the character input method output on the first character input screen 611 may be input by the user. In this case, a first character input screen 615 supporting emoji input may be output to the first display 841 (b). Selectable emojis may be output on the first character input screen 615.

If the electronic device 100 is changed to the unfolding state 620 (e.g., the first operation state 320 of FIG. 3) by the user, the second character input screen 621 may be output to the second display (e.g., the second display 843 of FIG. 8). For example, it is assumed that the change to the unfolding state 620 is made after receiving a text message and then selecting the emoji input method as the character input method. The second character input screen 621 may be a state display screen that is semi-transparently displayed on the home screen output to the second display 843. Information about the operation state of the electronic device 100 may be output on the state display screen. As information about the operation state, the state display screen may include, e.g., a function activated or deactivated in the electronic device 100 or emojis indicating the state of the function.

For example, when the character input function is activated in the folding state 610 and the emoji input method is selected and then changed to the unfolding state 620, the text message 627 output on the first character input screen 611 in the folding state 610 may also be output on the second character input screen 621. An input interface 623c may be output on the second character input screen 621 for continuous character input. In addition to the keypad for character input, the input interface 623c may include the emoji input method selection button 625c for continuously selecting the character input method (e.g., the emoji input method) selected in the folding state 610 even in the unfolding state 620. The user may continuously use the emoji input method used in the folding state 610 even in the unfolding state 620 by selecting the emoji input method selection button 625c output on the second character input screen 621.

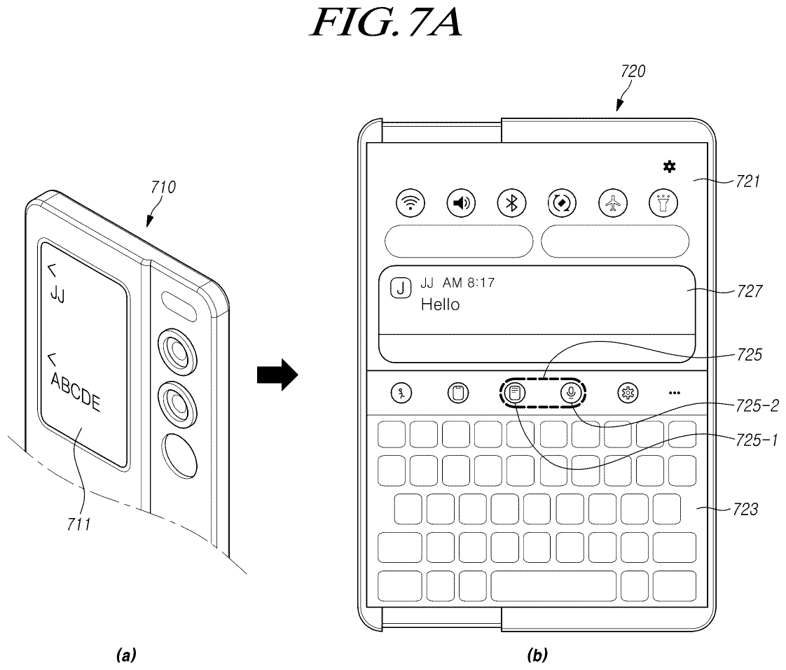

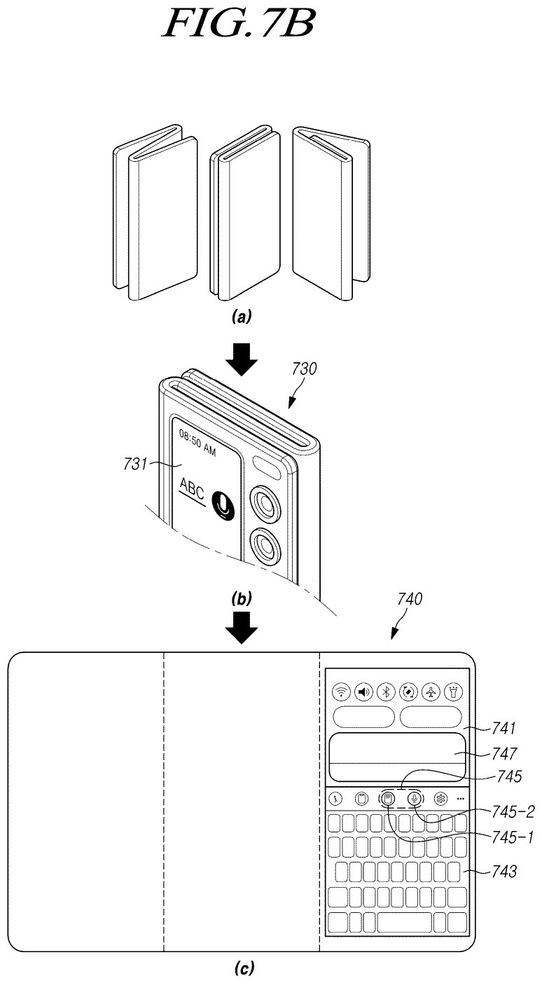

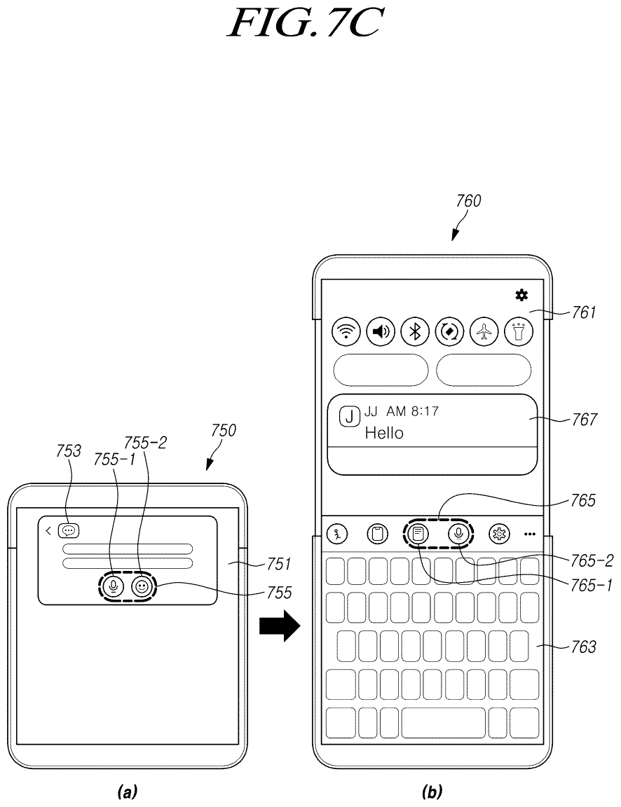

FIG. 7A is a view illustrating an example of changing a screen in order to continuously provide the character input when an operation state (e.g., the roll-down state or the roll-up state) is changed in an electronic device (e.g., the electronic device 100 of FIG. 1) according to an embodiment of the disclosure.

Referring to FIG. 7A, a first character input screen 711 may be output to the first display (e.g., the first display 841 of FIG. 8) in the roll-down state 710 (e.g., the first operation state 320 of FIG. 3) (a). The first display 841 may be provided on the rear surface of the electronic device 100.

The first character input screen 711 may include a text message, a button (e.g., the button 515, 517 of FIG. 5A or 5B) regarding a message processing option, or a button (e.g., the button 521, 523 of FIG. 5A or 5B) for selecting the character input method.

In an example, if the electronic device 100 is changed to the roll-up state 720 (e.g., the first operation state 320 of FIG. 3) by the user, the second character input screen 721 may be output to the second display (e.g., the second display 843 of FIG. 8) (b). The second display 843 may be provided on the front surface of the electronic device 100.

The second character input screen 721 may be a state display screen that is semi-transparently displayed on the home screen output to the second display 843. Information about the operation state of the electronic device 100 may be output on the state display screen. As information about the operation state, the state display screen may include, e.g., a function activated or deactivated in the electronic device 100 or emojis indicating the state of the function. For example, as the hidden display in the roll-up state 720 is exposed, the display area of the second display 843 may be extended compared to the first display 841.

In an example, when the character input function is activated and changes from the roll-down state 710 to the roll-up state 720, the electronic device 100 may display the text message 727, which is displayed on the first character input screen 711 in the roll-down state 710, on the second character input screen 721. An input interface 723 may be output on the second character input screen 721 for continuous character input. In addition to the keypad for character input, the input interface 723 may include the character input method selection button 725 for continuously selecting the character input method (e.g., the voice input method or the emoji input method) supported by the roll-down state 710 even in the roll-up state 720. The character input method selection button 725 may include, e.g., the emoji input method selection button 725-1 or the voice input method selection button 725-2. The user may continuously use the character input method used in the roll-down state 710 even in the roll-up state 720 by selecting one of the emoji input method selection button 725-1 or the voice input method selection button 725-2 output on the second character input screen 721.

FIG. 7B is a view illustrating an example of changing a screen in order to continuously provide the character input when an operation state (e.g., the folding state or the unfolding state) is changed in an electronic device (e.g., the electronic device 100 of FIG. 1) according to an embodiment of the disclosure.

Referring to FIG. 7B, the electronic device 100 may have a multi-folding structure. The multi-folding structure may be foldable in multiple stages (a). A first character input screen 731 may be output to the first display (e.g., the first display 841 of FIG. 8) in the folding state 730 (e.g., the first operation state 320 of FIG. 3) (b). The first character input screen 731 may include a text message, a button (e.g., the button 515, 517 of FIG. 5A or 5B) regarding a message processing option, or a button (e.g., the button 521, 523 of FIG. 5A or 5B) for selecting the character input method.

If the electronic device 100 is changed to the unfolding state 740 (e.g., the first operation state 320 of FIG. 3) by the user, the second character input screen 741 may be output to the second display (e.g., the second display 843 of FIG. 8) (c). For example, it is assumed that the change to the unfolding state 740 is made before the character input method is selected after receiving the text message. The second character input screen 741 may be a state display screen that is semi-transparently displayed on the home screen output to the second display 843. Information about the operation state of the electronic device 100 may be output on the state display screen. As information about the operation state, the state display screen may include, e.g., a function activated or deactivated in the electronic device 100 or emojis indicating the state of the function. For example, as the hidden display in the folding state 730 is exposed, the display area of the second display 843 may be extended compared to the first display 841.

When the character input function is activated and changes from the folding state 730 to the unfolding state 740, the electronic device 100 may display (747) the text message, which is displayed on the first character input screen 731 in the folding state 730, on the second character input screen 741. An input interface 743 may be output on the second character input screen 741 for continuous character input. In addition to the keypad for character input, the input interface 643 may include the character input method selection button 745 for continuously selecting the character input method (e.g., the voice input method or the emoji input method) supported by the folding state 730 even in the unfolding state 740. The character input method selection button 745 may include, e.g., the emoji input method selection button 745-1 or the voice input method selection button 745-2. The user may continuously use the character input method used in the folding state 730 even in the unfolding state 740 by selecting one of the emoji input method selection button 745-1 or the voice input method selection button 745-2 output on the second character input screen 741.

FIG. 7C is a view illustrating an example of changing a screen in order to continuously provide the character input when an operation state (e.g., the pull-down state or the pull-up state) is changed in an electronic device (e.g., the electronic device 100 of FIG. 1) according to an embodiment of the disclosure.

Referring to FIG. 7C, a first character input screen 751 may be output to the first display (e.g., the first display 841 of FIG. 8) in the pull-down state 750 (e.g., the first operation state 320 of FIG. 3) (a). The first character input screen 751 may be displayed in a partial area of the first display 841 provided on the front surface of the electronic device 100 in the pull-down state. The first character input screen 751 may include a text message 753, a button (e.g., the button 515, 517 of FIG. 5A or 5B) regarding a message processing option, or the character input method selection button 755. The character input method selection button 755 may include, e.g., the emoji input method selection button 755-1 (e.g., the button 521 of FIG. 5A or 5B) or the voice input method selection button 755-2 (e.g., the button 523 of FIG. 5A or 5B).

If the electronic device 100 is changed to the pull-up state 760 (e.g., the first operation state 320 of FIG. 3) by the user, the second character input screen 761 may be output to the second display (e.g., the second display 843 of FIG. 8) (b). The change from the pull-down state 750 to the pull-up state 760 may occur by moving the upper assembly of the electronic device 100 in a designated sliding direction (e.g., in the upward direction) by the user's manipulation. The second character input screen 761 may be displayed on the entire area of the second display 843 provided on the front surface of the electronic device 100 in the pull-up state.

The second character input screen 761 may be a state display screen that is semi-transparently displayed on the home screen output to the second display 843. Information about the operation state of the electronic device 100 may be output on the state display screen. As information about the operation state, the state display screen may include, e.g., a function activated or deactivated in the electronic device 100 or emojis indicating the state of the function. For example, as the hidden display in the pull-down state 750 is exposed, the display area of the second display 843 may be extended compared to the first display 841. For example, the first display 841 and the second display 843 may be configured as one display, and may be implemented in a structure in which the externally exposed display area may differ according to the operation state.

In an example, when the character input function is activated and changes from the pull-down state 750 to the pull-up state 760, the electronic device 100 may display (767) the text message, which is displayed on the first character input screen 751 in the pull-down state 750, on the second character input screen 761. An input interface 763 may be output on the second character input screen 761 for continuous character input. In addition to the keypad for character input, the input interface 763 may include the character input method selection button 765 for continuously selecting the character input method (e.g., the voice input method or the emoji input method) supported by the pull-down state 750 even in the pull-up state 760. The character input method selection button 765 may include, e.g., the emoji input method selection button 765-1 or the voice input method selection button 765-2. In an embodiment, the user may continuously use the character input method used in the pull-down state 750 even in the pull-up state 760 by selecting one of the emoji input method selection button 765-1 or the voice input method selection button 765-2 output on the second character input screen 761.

The embodiment proposed in the disclosure may be applied to the electronic device 100 having a slidable structure that is extendable in a horizontal direction in addition to the electronic device 100 having a slidable structure that is extendable in a vertical direction illustrated in FIG. 7C.

FIG. 8 is a block diagram illustrating an electronic device 100 (e.g., the electronic device 100 of FIG. 1) including a flexible display according to an embodiment of the disclosure.

Referring to FIG. 8, the flexible display included in the electronic device 100 may have, e.g., a foldable structure, a slidable structure, a rollable structure, or a multi-foldable structure. The electronic device 100 may include at least one processor 810 (e.g., the processor 120 of FIG. 1), a sensor unit 820 (e.g., the sensor module 176 of FIG. 1), a microphone 830 (e.g., the input module 150 of FIG. 1), a display module 840 (e.g., the display module 160 of FIG. 1) or memory 850 (e.g., the memory 130 of FIG. 1). Although not illustrated in the drawings, the electronic device 100 may omit, for example, at least one of the components or add one or more other components. Some (e.g., the sensor unit 820 and the microphone 830 or the sensor unit 820 and the display module 840) of the illustrated components may be integrated into one component (e.g., the sensor unit 820 or the display module 840).

The processor 810 may execute, e.g., software (e.g., a program) to control at least one other component (e.g., a hardware or software component) of the electronic device 100 connected with the processor 810 and may process or compute various data. In an example, as at least part of the data processing or computation, the processor 810 may store a command or data received from another component (e.g., the sensor unit 820) in the memory 850 (e.g., volatile memory), process the command or the data stored in the memory 850, and store resulting data in the memory 850.

The processor 810 may be electrically coupled to the sensor unit 820, the microphone 830, the display module 840 (the first display 841 or the second display 843) or the memory 850. The electrical coupling may mean, e.g., a connection capable of transmitting/receiving an electrical signal such as a control signal or a sensing signal between components. The processor 810 may control the sensor unit 820, the microphone 830, the display module 840, or the memory 850 based on the electrical coupling. For example, the processor 810 may independently control the first display 841 or the second display 843 included in the display module 840. Although one processor 810 is illustrated in the drawings, the electronic device 100 may include a plurality of processors. For example, the electronic device 100 may include a processor for each function such as application control, communication control, or display control.

In an embodiment, the processor 810 may include a main processor (e.g., a central processing unit (CPU) or an application processor (AP)), or an auxiliary processor (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 100 includes the main processor and the auxiliary processor, the auxiliary processor may be configured to use lower power than the main processor or to be specified for a designated function. The auxiliary processor may be implemented separately from, or as part of, the main processor.

The auxiliary processor may control at least some of functions or states related to at least one component (e.g., the display module 840 or the sensor unit 820) of the electronic device 100, instead of the main processor while the main processor is in an inactive (e.g., sleep) state or along with the main processor while the main processor is an active state (e.g., executing an application). As one example, the auxiliary processor (e.g., an image signal processor or a communication processor) may be implemented as part of another component (e.g., the display module 840) functionally related to the auxiliary processor 123. As an example, the auxiliary processor (e.g., the neural processing unit) may include a hardware structure specified for artificial intelligence model processing. The artificial intelligence model may be generated via machine learning. Such learning may be performed, e.g., by the electronic device 100 where the artificial intelligence is performed or via a separate server. Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The sensor unit 820 may detect, for example, an operation state (e.g., opening or closing of the folder) of the electronic device 100 or an environmental state (e.g., the user's state) outside the electronic device 100, and generate an electrical signal or data value corresponding to the detected state. The sensor unit 820 may include, e.g., a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor. For example, one or a combination of the gyro sensor, the magnetic sensor, or the acceleration sensor may sense the operation state (e.g., folding state or unfolding state) of the electronic device 100.

The microphone 830 may convert, for example, an audible signal generated from an external sound source into an electrical signal. The microphone 830 may transfer the electrical signal, resulting from converting the audible signal, to the processor 810. The audible signal converted into an electrical signal by the microphone 830 may be the user's voice signal.

The display module 840 may visually provide information to the outside (e.g., a user) of the electronic device 100. The display 840 may include, for example, a display, a hologram device, or a projector and control circuitry to control a corresponding one of the display, hologram device, and projector. The display module 840 may include a touch sensor configured to detect a touch, or a pressure sensor configured to measure the intensity of a force generated by the touch.

According to an example, the display module 840 may include a plurality of displays. The display module 840 may include, e.g., a first display 841 or a second display 843. The screen size of the first display 841 may be different from that of the second display 843. For example, the screen area of the first display 841 may be relatively smaller than that of the second display 843.

The first display 841 included in the display module 840 may be activated in response to the occurrence of a screen display event (e.g., text message reception, chat text reception, search request) in the first operation state 320 (e.g., the folding state) of the electronic device 100. For example, the first display 841 may output a screen (e.g., the first character input screen 611 of FIG. 6A, 6B, or 6C) which is to serve as an interface with the user in the folding state of the electronic device 100.

For example, the second display 843 included in the display module 840 may be activated in response to the occurrence of a screen display event (e.g., text message reception, chat text reception, search request, and specific application program execution) in the second operation state 330 (e.g., the unfolding state) of the electronic device 100. The second display 843 may output, e.g., a screen (e.g., the second character input screen 621 of FIG. 6A, 6B, or 6C) which is to serve as an interface with the user in the unfolding state of the electronic device 100.

In an embodiment, the memory 850 may store various data used by at least one component (e.g., the processor 810 or the sensor unit 820) of the electronic device 100. The data may include, e.g., input data or output data for software (e.g., program) and related commands. The memory 850 may include a volatile memory or a non-volatile memory. The program that may be stored as software in the memory 850 may include, e.g., an operating system, middleware, or applications.

According to an example, the processor 810 may perform overall control for outputting a first character input screen (e.g., the first character input screen 611 of FIG. 6A, 6B, or 6C) to the first display 841 in the first operation state (e.g., the first operation state 320 of FIG. 3).

More specifically, when the character input event occurs in the first operation state (e.g., the folding state), the processor 810 may output a screen corresponding to the generated character input event to the first display 841. The processor 810 may determine a screen to be output to the first display 841 according to the type that generated the character input event. For example, if the character input event is based on the reception of the text message, the processor 810 may output a character input screen (e.g., the first character input screen 611 of FIG. 6A, 6B, or 6C) that includes a button for selecting the character input method (e.g., voice input or emoji input) to input the answer text along with the received text to the first display 841.

The processor 810 may select a button for determining the character input method by the user in the first operation state 320, and display a character input by the character input method corresponding to the selected button on the first display 841.

For example, when the emoji input method is selected as the character input method, the processor 810 may output emojis that the user may select to the first display 841. If the user selects at least one emoji from among the emojis output to the first display 841, the processor 810 may display the character corresponding to the selected at least one emoji on the first display 841.

When the voice input method is selected as the character input method, the processor 810 may display a button for the user to start or end the voice input on the first display 841. When the user inputs a voice by manipulating the button displayed to the first display 841, the processor 810 may display the character corresponding to the input voice on the first display 841 or execute a command corresponding to the voice.

According to an example, the processor 810 may perform overall control for outputting a second character input screen (e.g., the second character input screen 621 of FIG. 6A, 6B, or 6C) to the second display 843 in the second operation state (e.g., the second operation state 330 of FIG. 3).

Specifically, when a state switching event occurs in the first operation state 320, the processor 810 may transition to the second operation state 330 (e.g., the unfolding state) and output a second character input screen corresponding to the first character input screen that was output to the first display 841 in the first operation state 320. The state switching event may be generated, e.g., by switching the electronic device 100 from the folding state to the unfolding state. The processor 810 may determine a screen to be output to the second display 843, e.g., by the type that generated the character input event and the character input method (e.g., the voice input method or the emoji input method) that may be provided in the first operation state 320. For example, if the character input event is based on the reception of a text message and the character input method in the first operation state 320 is the emoji input method, the processor 810 may output a character input screen (e.g., an input interface) including a button for selecting the emoji input method used in the first operation state 320 along with the received text to the second display 843.

When one of the character input methods provided in the first operation state 320 included in the input interface is selected by the user in the second operation state 330, the processor 810 may provide the character input method provided in the first operation state 320, even in the second operation state 330. In this case, the user may continuously use the character input method used in the first operation state 320 even in the second operation state 330. For example, the processor 810 may have a button included in the input interface selected according to the character input method used by the user in the first operation state 320, and display the character input by the character input method corresponding to the selected button on the second display 843.

In an example, when the character input method is selected in the first operation state 320, or the used emoji input method is selected, the processor 810 may output emojis that the user may select to the second display 843. If the user selects at least one emoji from among the emojis output to the second display 843, the processor 810 may display the character corresponding to the selected at least one emoji on the second display 843.

When the character input method is selected in the first operation state 320, or the used voice input method is selected, the processor 810 may display a button for the user to start or end the voice input on the second display 843. When the user inputs a voice by manipulating the button displayed to the second display 843, the processor 810 may display the character corresponding to the input voice on the second display 843 or execute a command corresponding to the voice.

According to an embodiment, a method for display in an electronic device 100 may comprise an operation 415 of outputting a first character input screen 611 to a first display 841 in a first operation state 320. The method may comprise an operation 417, 421 of outputting a second character input screen 621, providing continuity of character input in the first display 841, to a second display 843 in response to an occurrence 327 of a transition event from the first operation state 320 to a second operation state 330. The first display 841, which is activated in the first operation state 320, may have a relatively smaller screen size than the second display 843, which is activated in the second operation state 330. The second character input screen 621 may include an input interface 623a, 623b, 623c having one or more input buttons for selecting a character input method used in the first operation state 320.

In another embodiment, the first operation state 320 may be a folding state 610 or a roll-down state 710, and the second operation state 330 may be an unfolding state 620 or a roll-up state 720.

In an embodiment, the operation 417, 421 of outputting the second character input screen 621 may include an operation 421 of outputting the second character input screen 621 including an input interface 623a, 623b having a voice input button 625a-2, 625b, in response to an occurrence of the transition event from the first operation state 320, in which character input is performed by voice, to the second operation state 330.

In yet another embodiment, the operation 417, 421 of outputting the second character input screen 621 may include an operation 335, 423 of displaying a character input by voice on the second character input screen 621 in response to selecting the voice input button 625a-2, 625b provided in the input interface 623a, 623b.

In an embodiment, the operation 417, 421 of outputting the second character input screen 621 may include an operation 421 of outputting the second character input screen 621 including an input interface 623a, 623c having an emoji input button 625a-1, 625c, in response to an occurrence 327 of the transition event from the first operation state 320, in which character input is performed by an emoji, to the second operation state 330.

The operation 417, 421 of outputting the second character input screen 621 may include an operation 421 of outputting inputtable emojis 533 to the second character input screen 621 in response to selecting the emoji input button 625a-1, 625c.

In an embodiment, the operation 417, 421 of outputting the second character input screen 621 may include an operation 335, 423 of displaying an emoji 541 selected from among the emojis 533 on the second character input screen 621.

The operation 417, 421 of outputting the second character input screen 621 may include an operation 421 of outputting the second character input screen 621 enabling character input by a character input method in the first operation state 320, in response to an occurrence 327 of the transition event to the second operation state 330 in a state in which character input is not completed in the first display 841.

According to an embodiment, an electronic device 100 may comprise a first display 841, a second display 843 having a relatively larger screen size than the first display 841, and at least one processor 810 operably connected to the first display 841 or the second display 843. The at least one processor 810 may control the first display 841 to output a first character input screen 611 in a first operation state 320. The at least one processor 810 may control the second display 843 to output a second character input screen 621, providing continuity of character input in the first display 841, in response to an occurrence 327 of a transition event from the first operation state 320 to a second operation state 330. Here, the second character input screen 621 may be configured to include an input interface 623a, 623b, 623c having one or more input buttons for selecting a character input method used in the first operation state 320.

In another embodiment, the first operation state 320 may be a folding state 610 or a roll-down state 710, and the second operation state 330 may be an unfolding state 620 or a roll-up state 720.

In an embodiment, the at least one processor 810 may control the second display 843 to output the second character input screen 621 including an input interface 623a, 623b having a voice input button 625a-2, 625b, in response to an occurrence 327 of the transition event from the first operation state 320, in which character input is performed by voice, to the second operation state 330.

The at least one processor 810 may control the second display 843 to display a character input by voice on the second character input screen 621 in response to selecting the voice input button 625a-2, 625b provided in the input interface 623a, 623b.

In an embodiment, the at least one processor 810 may control the second display 843 to output the second character input screen 621 including an input interface 623a, 623c having an emoji input button 625a-1, 625c, in response to an occurrence 327 of the transition event from the first operation state 320, in which character input is performed by an emoji, to the second operation state 330.

The at least one processor 810 may control the second display 843 to output inputtable emojis 533 to the second character input screen 621 in response to selecting the emoji input button 625a-1, 625c.

In another embodiment, the at least one processor 810 may control the second display 843 to display an emoji 541 selected from among the emojis 533 on the second character input screen 621.

In an embodiment, the at least one processor 810 may control the second display 843 to output the second character input screen 621 for character input by a character input method in the first operation state 320, in response to an occurrence 327 of the transition event to the second operation state 330 in a state in which character input is not completed in the first display 841.

The electronic device according to some embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., the memory 850) that is readable by a machine (e.g., the electronic device 100). For example, a processor (e.g., the processor 810) of the machine (e.g., the electronic device 100) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

In an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to some embodiments, each component (e.g., a module or a program) of the above-described components may include a single entity or multiple entities. Some of the plurality of entities may be separately disposed in different components. According to other embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for display in an electronic device, the method comprising:
outputting a first character input screen to a first display in a first operation state; and
outputting a second character input screen, providing continuity of character input in the first display, to a second display in response to an occurrence of a transition event from the first operation state to a second operation state,
wherein the first display, which is activated in the first operation state, has a relatively smaller screen size than the second display, which is activated in the second operation state, and
wherein the second character input screen includes an input interface having one or more input buttons for selecting a character input method used in the first operation state.

2. The method of claim 1, wherein the first operation state is a folding state, and the second operation state is an unfolding state.

3. The method of claim 1, wherein the first operation state is a roll-down state, and the second operation state is a roll-up state.

4. The method of claim 1, wherein the outputting the second character input screen includes:
outputting the second character input screen including an input interface having a voice input button, in response to an occurrence of the transition event from the first operation state, in which character input is performed by voice, to the second operation state; and
displaying a character input by voice on the second character input screen in response to selecting the voice input button provided in the input interface.

5. The method of claim 1, wherein the outputting the second character input screen includes outputting the second character input screen including an input interface having an emoji input button, in response to an occurrence of the transition event from the first operation state, in which character input is performed by an emoji, to the second operation state.

6. The method of claim 5, wherein the outputting the second character input screen includes outputting inputtable emojis to the second character input screen in response to selecting the emoji input button.

7. The method of claim 6, wherein the outputting the second character input screen includes displaying an emoji selected from among the emojis on the second character input screen.

8. The method of claim 1, wherein the outputting the second character input screen includes outputting the second character input screen enabling character input by a character input method in the first operation state, in response to an occurrence of the transition event to the second operation state in a state in which character input is not completed in the first display.

9. An electronic device, comprising:
a first display;
a second display having a relatively larger screen size than the first display;
memory, comprising one or more storage media, storing instructions; and
at least one processor communicatively coupled to the first display or the second display, and the memory,
wherein the instructions, when executed by the at least one processor individually or collectively, cause the electronic device to:
control the first display (841) to output a first character input screen in a first operation state, and
control the second display to output a second character input screen, providing continuity of character input in the first display, in response to an occurrence of a transition event from the first operation state to a second operation state, and
wherein the second character input screen is configured to include an input interface having one or more input buttons for selecting a character input method used in the first operation state.

10. The electronic device of claim 9, wherein the first operation state is a folding state, and the second operation state is an unfolding state.

11. The electronic device of claim 9, wherein the first operation state is a roll-down state, and the second operation state is a roll-up state.

12. The electronic device of claim 9, wherein the instructions, when executed by the at least one processor individually or collectively, further cause the electronic device to:
controls the second display to output the second character input screen including an input interface having a voice input button, in response to an occurrence of the transition event from the first operation state, in which character input is performed by voice, to the second operation state; and
controls the second display to display a character input by voice on the second character input screen in response to selecting the voice input button (625a-2, 625b) provided in the input interface.

13. The electronic device of claim 9, wherein the instructions, when executed by the at least one processor individually or collectively, further cause the electronic device to:
control the second display to output the second character input screen including an input interface having an emoji input button, in response to an occurrence of the transition event from the first operation state, in which character input is performed by an emoji, to the second operation state.

14. The electronic device of claim 13, wherein the instructions, when executed by the at least one processor individually or collectively, further cause the electronic device to:
control the second display to output inputtable emojis to the second character input screen in response to selecting the emoji input button; and
control the second display to display an emoji selected from among the emojis on the second character input screen.

15. The electronic device of claim 9, wherein the instructions, when executed by the at least one processor individually or collectively, further cause the electronic device to:
control the second display to output the second character input screen for character input by a character input method in the first operation state, in response to an occurrence of the transition event to the second operation state in a state in which character input is not completed in the first display.

16. One or more non-transitory computer-readable storage media storing one or more computer programs including computer-executable instructions that, when executed by one or more processors of an electronic device individually or collectively, cause the electronic device to perform operations, the operations comprising:
outputting a first character input screen to a first display in a first operation state; and
outputting a second character input screen, providing continuity of character input in the first display, to a second display in response to an occurrence of a transition event from the first operation state to a second operation state,
wherein the first display, which is activated in the first operation state, has a relatively smaller screen size than the second display, which is activated in the second operation state, and
wherein the second character input screen includes an input interface having one or more input buttons for selecting a character input method used in the first operation state.

17. The one or more non-transitory computer-readable storage media of claim 16, wherein the first operation state is one of a folding state or a roll-down state, and the second operation state is one of an unfolding state or a roll-up state.

18. The one or more non-transitory computer-readable storage media of claim 16, wherein the outputting the second character input screen includes:
outputting the second character input screen including an input interface having a voice input button, in response to an occurrence of the transition event from the first operation state, in which character input is performed by voice, to the second operation state; and
displaying a character input by voice on the second character input screen in response to selecting the voice input button provided in the input interface.

19. The one or more non-transitory computer-readable storage media of claim 18, wherein the outputting the second character input screen includes:
outputting the second character input screen including an emoji input button, in response to an occurrence of the transition event from the first operation state, in which character input is performed by an emoji, to the second operation state;
outputting inputtable emojis to the second character input screen in response to selecting the emoji input button; and
displaying an emoji selected from among the emojis on the second character input screen.

20. The one or more non-transitory computer-readable storage media of claim 16, wherein the outputting the second character input screen includes outputting the second character input screen enabling character input by a character input method in the first operation state, in response to an occurrence of the transition event to the second operation state in a state in which character input is not completed in the first display.
